(19) United States
(12) Patent Application Publication
(10) Pub. No.: US 2014/0200017 A1
(43) Pub. Date: Jul. 17, 2014

(54) COGNITIVE RADIO APPARATUS AND COMMUNICATION METHOD THEREOF

(71) Applicant: Electronics and Telecommunications Research Institute, Daejeon (KR)

(72) Inventors: Jung Sun UM, Daejeon (KR); Jae Hyun PARK, Busan (KR); Byung Jang JEONG, Daejeon (KR); Sang Won KIM, Daejeon (KR); Jin Suk PAK, Daejeon (KR)

(21) Appl. No.: 13/920,504

(22) Filed: Jun. 18, 2013

(30) Foreign Application Priority Data
Jan. 14, 2013 (KR) 10-2013-0004069

(51) Int. Cl. H04L 5/06

(52) U.S. Cl. CPC H04L 5/06
USPC 455/452.1

(57) ABSTRACT

To perform communication in a cognitive radio network, a cognitive radio apparatus according to an exemplary embodiment includes: an estimation module configured to generate a channel estimation signal to be transmitted to a predetermined reception apparatus positioned in a predetermined channel in the case of selecting the predetermined channel from among multiple channels; a communication module configured to transmit the channel estimation signal to the predetermined reception apparatus, and to receive a channel response signal from the predetermined reception apparatus; and a control module configured to control the communication module so that at least one of a communication signal set with respect to the predetermined channel and a variable communication signal obtained by varying the communication signal is transmitted to the predetermined reception apparatus, when it is determined that the predetermined channel is positioned in a deep fading section based on the channel response signal.

### CROSS-REFERENCE TO RELATED APPLICATIONS

This application claims priority to and the benefit of Korean Patent Application No. 10-2013-0004069 filed in the Korean Intellectual Property Office on Jan. 14, 2013, the entire contents of which are incorporated herein by reference.

### TECHNICAL FIELD

An exemplary embodiment relates to a cognitive radio apparatus and a communication method thereof, and more particularly, to a cognitive radio apparatus that may easily transmit a communication signal having a relatively excellent frequency characteristic to a predetermined reception apparatus positioned in a predetermined channel in a cognitive radio network, and a communication method thereof.

### BACKGROUND ART

A cognitive radio technology refers to a technology that actively recognizes a frequency band and finds and thereby uses a channel unoccupied by another user. The cognitive radio technology is currently proposed as a solution for insufficient frequency resources.

The cognitive radio technology includes a primary user who has a valid right (license) and a secondary user who does not have a valid right.

One of the most important requirements in the cognitive radio technology is that the primary user should not be hurt by a frequency band use of the secondary user.

Currently, as a method for configuring the cognitive radio technology, a method of accessing a database and a centralized cooperative sensing method are present.

The centralized cooperative sensing method is a method that locates a central base station configured to control all of the cognitive radio terminals, that is, cognitive radio nodes, to collect information, and to make determination, and enables each of the cognitive radio nodes to sense each channel and to select a channel based on an instruction of the central base station.

In the aforementioned centralized cooperative sensing method, the central base station needs to perform a role of selecting an available channel so that a secondary user under the management of the central base station may use a cognitive radio channel, and provide the selected available channel to the secondary user.

Currently, in the cognitive radio technology, there is ongoing research for improving a frequency characteristic of a communication signal between a primary user and a secondary user even in a case in which a selected channel is positioned in a fading section.

### SUMMARY OF THE INVENTION

An exemplary embodiment has been made in an effort to provide a cognitive radio apparatus that may easily transmit a communication signal having a relatively excellent frequency characteristic to a predetermined reception apparatus positioned in a predetermined channel in a cognitive radio network, and a communication method thereof.

An exemplary embodiment provides a cognitive radio apparatus for performing communication in a cognitive radio network, the apparatus including: an estimation module configured to generate a channel estimation signal to be transmitted to a predetermined reception apparatus positioned in a predetermined channel, in the case of selecting the predetermined channel from among multiple channels; a communication module configured to transmit the channel estimation signal to the predetermined reception apparatus, and to receive a channel response signal from the predetermined reception apparatus; and a control module configured to control the communication module so that at least one of a communication signal set with respect to the predetermined channel and a variable communication signal obtained by varying the communication signal is transmitted to the predetermined reception apparatus, when it is determined that the predetermined channel is positioned in a deep fading section based on the channel response signal.

Another exemplary embodiment provides a communication method of a cognitive radio apparatus for performing communication in a cognitive radio network, the method including: selecting a predetermined channel from among multiple channels; generating a channel estimation signal to be transmitted to a predetermined reception apparatus positioned in the predetermined channel; transmitting the channel estimation signal to the predetermined reception apparatus; determining whether the predetermined channel is positioned in a deep fading section based on a channel response signal transmitted from the predetermined reception apparatus; and transmitting, to the predetermined reception apparatus, at least one of a communication signal set with respect to the predetermined channel and a variable communication signal obtained by varying the communication signal, when the predetermined channel is positioned in the deep fading section.

According to exemplary embodiments, a cognitive radio communication apparatus and a communication method thereof may transmit at least one of a set communication signal and a variable communication signal obtained by varying the communication signal to a reception apparatus positioned in a predetermined channel even when the predetermined channel selected in a cognitive radio network is positioned in a deep fading section, thereby increasing a frequency response characteristic (signal-to-noise ratio (SNR)) by signal attenuation and the like which occurs in the deep fading section, and increasing a yield of channel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a control configuration of a cognitive radio apparatus according to an exemplary embodiment.

FIG. 2 is a diagram illustrating a first exemplary embodiment in relation to an operation of the cognitive radio apparatus of FIG. 1.

FIG. 3 is a flowchart illustrating a communication method of a cognitive radio apparatus according to an exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description simply exemplifies a principle of the invention. Accordingly, although not clearly described or illustrated in the present specification, those skilled in the art may configure the principle of the invention and may invent a variety of apparatuses included in the concept and scope of the invention. All of the conditional terminologies and exemplary embodiments enumerated in the present specification are clearly intended only for the purpose of understanding the concept of the invention, in principle. Accordingly, the invention should not be understood to be limited to the exemplary embodiments and states particularly enumerated as above.

All of the detailed descriptions in which a predetermined exemplary embodiment in addition to the principle of the invention, perspectives, and exemplary embodiments are described should be understood to include structural and functional equivalents of the above matters. The equivalents should be understood to include equivalents currently known and also include equivalents to be developed in the future, that is, all of the devices invented to perform the same function regardless of a type of structure.

Accordingly, for example, a block diagram of the present specification should be understood to indicate an exemplary conceptual perspective of embodying the principle of the invention. Similarly, all of the flowcharts, state conversion diagrams, pseudo codes, and the like, should be understood to indicate a variety of processes that can be expressed by a computer in a computer-readable medium, and that are implemented by the computer or a processor regardless of whether the computer or the processor is clearly illustrated.

Functions of various devices illustrated in the drawings that include the processor or a functional block indicated as a concept similar thereto may be provided by use of exclusive hardware and hardware having a capability of executing software in association with appropriate software. When such functions are provided by the processor, the functions may be provided by a single exclusive processor, a single shared processor, or a plurality of individual processors, and a portion thereof may be shared.

Clear use of the processor, control, or a terminology proposed as a concept similar thereto should not be interpreted by exclusively citing hardware having the capability of executing software, and should be understood to implicitly include ROM, RAM, and a nonvolatile memory for storing digital signal processor (DSP) hardware and software without limitation. Known and commonly-used other hardware may also be included.

In the claims of the present specification, a constituent element expressed as a means to perform a function disclosed in the detailed description is intended to include, for example, a combination of circuit devices configured to perform the function or all of the methods of performing the function that includes every type of software including firmware/micro code, and the like. The constituent element is combined with an appropriate circuit for executing the above software in order to perform the function. The invention defined by the claims is combined with functions provided by variously enumerated means and combined with a scheme required by the claims. Accordingly, any means capable of providing the function should be understood to be equivalent to as verified from the present specification.

The aforementioned objects, features, and advantages will become further obvious through the following detailed description which is associated with the accompanying drawings and accordingly, those skilled in the art may easily implement the technical spirit of the invention. When it is determined that the detailed description related to a related known function or configuration may make the purpose of the present invention unnecessarily ambiguous in describing the invention, the detailed description will be omitted herein.

Hereinafter, exemplary embodiments will be described in detail with reference to the accompanying drawings.

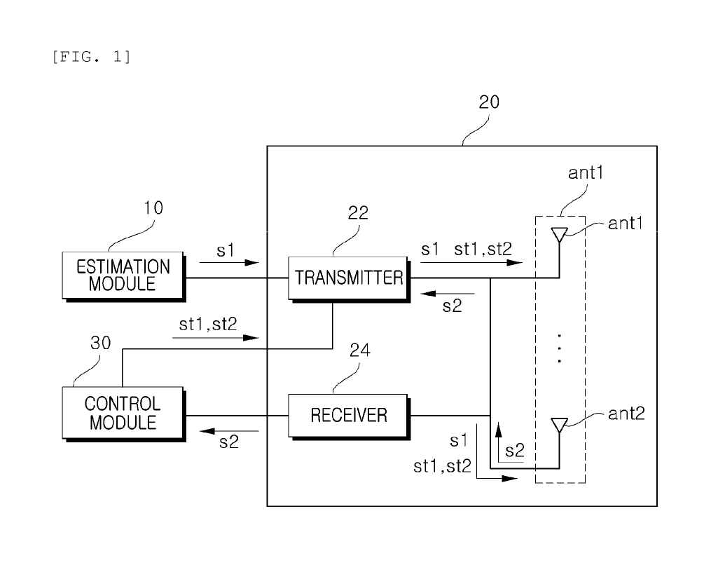

FIG. 1 is a block diagram illustrating a control configuration of a cognitive radio apparatus according to an exemplary embodiment.

Referring to FIG. 1, the cognitive radio apparatus includes an estimation module 10, a communication module 20, and a control module 30.

In the case of selecting a predetermined channel from among multiple channels, the estimation module 10 generates a channel estimation signal s1 to be transmitted to a predetermined reception apparatus positioned in the predetermined channel.

That is, the estimation module 10 generates the channel estimation signal s1 for determining a channel characteristic of the predetermined channel, that is, whether the predetermined channel is positioned in a deep fading section, before transmitting a communication signal to the predetermined reception apparatus positioned in the predetermined channel.

The estimation module 10 transfers the generated channel estimation signal s1 to the communication module 20.

The communication module 20 transmits, to the predetermined reception apparatus, the channel estimation signal s1 transferred from the estimation module 10, and receives a channel response signal s2 from the predetermined reception apparatus.

That is, the communication module 20 includes at least one antenna ant, and includes a transmitter 22 configured to transmit at least one of the channel estimation signal s1, a communication signal st1 generated by the control module 30, and a variable communication signal st2 to the predetermined reception apparatus via at least one antenna ant, and a receiver 24 configured to receive the channel response signal s2 from the predetermined reception apparatus via at least one antenna ant.

Here, at least one antenna ant may simultaneously communicate with a plurality of reception apparatuses, and may simultaneously transmit a plurality of signals to a single reception apparatus.

When it is determined that the predetermined channel is positioned in the deep fading section based on the channel response signal s2, the control module 30 controls the communication module 20 so that at least one of the communication signal st1 set with respect to the predetermined channel and the variable communication signal st2 obtained by varying the communication signal st1 is transmitted to the predetermined reception apparatus

That is, the control module 30 determines whether the predetermined channel is positioned in the deep fading section based on a frequency response characteristic obtained by analyzing the transferred channel response signal s2.

For example, the control module 30 determines that the predetermined channel is positioned in the deep fading section when the frequency response characteristic of the channel response signal s2 is low, and determines that the predetermined channel is not positioned in the deep fading section when the frequency response characteristic of the channel response signal s2 is high.

In this instance, the control module 30 generates the variable communication signal st2 by varying a frequency condition of the communication signal st1 based on a depth of the deep fading section, that is, the frequency response characteristic.

Here, the frequency condition includes at least one of a frequency phase, amplitude, and a beam pattern.

As described above, in the case of selecting the predetermined channel, the control module 30 may verify the frequency response characteristic of the predetermined channel through the channel estimation signal s1 preset between the cognitive radio apparatus and the predetermined reception apparatus with respect to the predetermined channel.

Next, the control module 30 may frequency-convert the preset communication signal st1 to the variable communication signal st2 based on the frequency response characteristic and thereby transmit the variable communication signal st2 to the predetermined reception apparatus, thereby enabling the predetermined reception apparatus to receive an accurate signal.

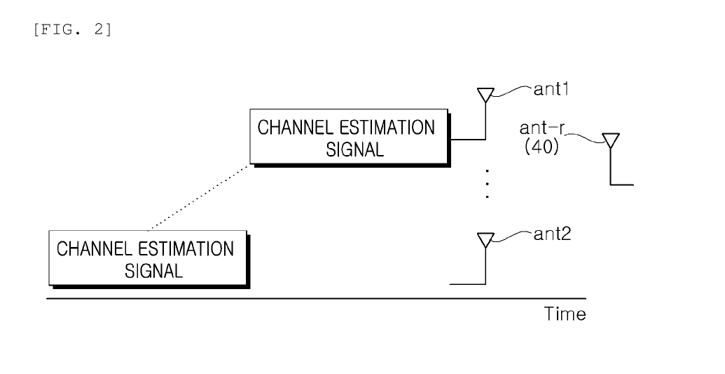

FIG. 2 is a diagram illustrating a first exemplary embodiment in relation to an operation of the cognitive radio apparatus of FIG. 1.

FIG. 2 illustrates an exemplary embodiment in relation to the operation of the cognitive radio apparatus.

Referring to FIG. 2, the cognitive radio apparatus includes at least one antenna ant, and may transmit a communication signal about the same information to a predetermined reception apparatus 40.

Even though the exemplary embodiment describes that at least one antenna ant includes a first antenna anti and a second antenna ant2, that is, two antennas, the exemplary embodiment is not limited thereto.

That is, the cognitive radio apparatus generates a channel estimation signal s1 and transmits the generated channel estimation signal s1 to the predetermined reception apparatus 40 in order to determine a frequency response characteristic of a predetermined channel available among currently communicating multiple channels.

The cognitive radio apparatus transmits the channel estimation signal s1, predefined at a different point in time, to an antenna ant_r included in the predetermined reception apparatus 40 as the predetermined channel, using the first antenna anti and the second antenna ant2.

In this instance, the cognitive radio apparatus may receive a channel response signal s2 transmitted from the predetermined reception apparatus 40 using at least one of the first antenna anti and the second antenna ant2.

Here, the cognitive radio apparatus obtains channel information by analyzing the channel response signal s2 transmitted to at least one of the first antenna ant1 and the second antenna ant2.

Next, the cognitive radio apparatus generates a variable communication signal st2varied by performing signal processing of the preset communication signal st1 based on a frequency condition, in order to increase a frequency response characteristic between the cognitive radio apparatus and the predetermined reception apparatus 40 using the obtained channel information.

The cognitive radio apparatus transmits at least one of the communication signal st1 and the variable communication signal st2 to the predetermined reception apparatus 40 using at least one of the first antenna anti and the second antenna ant2.

The predetermined reception apparatus 40 may obtain information of the communication signal st1 based on at least one of the communication signal st1 and the variable communication signal st2 transmitted from the cognitive radio apparatus.

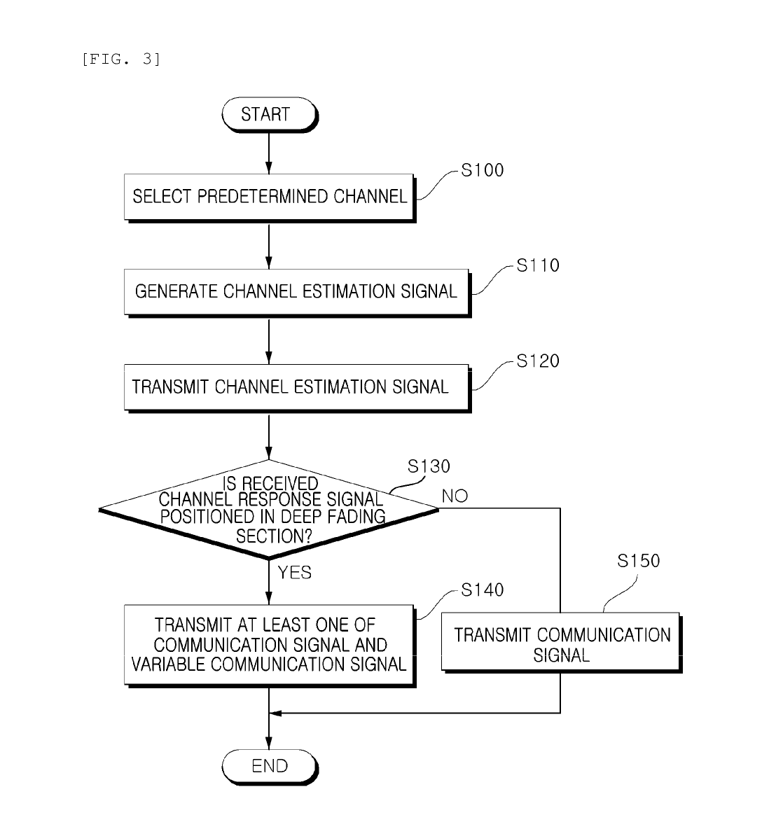

FIG. 3 is a flowchart illustrating a communication method of a cognitive radio apparatus according to an exemplary embodiment.

Referring to FIG. 3, the cognitive radio apparatus selects a predetermined channel from among multiple channels (S100), generates a channel estimation signal to be transmitted to a predetermined reception apparatus positioned in the predetermined channel (S110), and transmits the channel estimation signal to the predetermined reception apparatus (S120).

That is, in the case of selecting the predetermined channel from among the multiple channels, the estimation module 10 generates a channel estimation signal s1 to be transmitted to the predetermined reception apparatus positioned in the predetermined channel.

The estimation module 10 generates the channel estimation signal s1 for determining a channel characteristic of the predetermined channel, that is, whether the predetermined channel is positioned in a deep fading section, before transmitting a communication signal to the predetermined reception apparatus positioned in the predetermined channel.

The estimation module 10 transfers the generated channel estimation signal s1 to the communication module 20. The communication module 20 transfers, to the predetermined reception apparatus, the channel estimation signal s1 transferred from the estimation module 10.

The cognitive radio apparatus determines whether the predetermined channel is positioned in the deep fading section based on a channel response signal s2 transmitted from the predetermined reception apparatus (S130), and transmits, to the predetermined reception apparatus, at least one of the communication signal st1 set with respect to the predetermined channel and a variable communication signal st2 obtained by varying the communication signal st1 when the predetermined channel is positioned in the deep fading section (S140), or transmits the communication signal when the predetermined channel is not positioned in the deep fading section (S150).

That is, when it is determined that the predetermined channel is positioned in the deep fading section based on the channel response signal s2 transmitted from the predetermined reception apparatus, the control module 30 controls the communication module 30 so that at least one of the communication signal st1 set with respect to the predetermined channel and the variable communication signal st2 obtained by varying the communication signal st1 is transmitted to the predetermined reception apparatus.

That is, the control module 30 determines whether the predetermined channel is positioned in the deep fading section based on a frequency response characteristic obtained by analyzing the transferred channel response signal s2.

For example, the control module 30 determines that the predetermined channel is positioned in the deep fading section when the frequency response characteristic of the channel response signal s2 is low, and determines that the predetermined channel is not positioned in the deep fading section when the frequency response characteristic of the channel response signal s2 is high.

In this instance, the control module 30 generates the variable communication signal st2 by varying a frequency condition of the communication signal st1 based on a depth of the deep fading section, that is, the frequency response characteristic.

Here, the frequency condition includes at least one of a frequency phase, amplitude, and a beam pattern.

As described above, in the case of selecting the predetermined channel, the control module 30 may verify the frequency response characteristic of the predetermined channel through the channel estimation signal s1 preset between the cognitive radio apparatus and the predetermined reception apparatus with respect to the predetermined channel.

Next, the control module 30 may frequency-convert the preset communication signal st1 to the variable communication signal st2 based on the frequency response signal and thereby transmit the variable communication signal st2 to the predetermined reception apparatus, thereby enabling the predetermined reception apparatus to receive an accurate signal.

When the predetermined channel is not positioned in the deep fading section based on the frequency response characteristic, the control module 30 transmits the set communication signal st1.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A cognitive radio apparatus for performing communication in a cognitive radio network, the apparatus comprising:
an estimation module configured to generate a channel estimation signal to be transmitted to a predetermined reception apparatus positioned in a predetermined channel, in the case of selecting the predetermined channel from among multiple channels;
a communication module configured to transmit the channel estimation signal to the predetermined reception apparatus, and to receive a channel response signal from the predetermined reception apparatus; and
a control module configured to control the communication module so that at least one of a communication signal set with respect to the predetermined channel and a variable communication signal obtained by varying the communication signal is transmitted to the predetermined reception apparatus, when it is determined that the predetermined channel is positioned in a deep fading section based on the channel response signal.

2. The apparatus of claim 1, wherein the channel estimation signal is a signal for obtaining channel information about the predetermined channel.

3. The apparatus of claim 1, wherein
the communication module includes at least one antenna, and
the communication module includes:
a transmitter configured to transmit at least one of the channel estimation signal, the communication signal, and the variable communication signal to the predetermined reception apparatus via the at least one antenna; and
a receiver configured to receive the channel response signal from the predetermined reception apparatus via the at least one antenna.

4. The apparatus of claim 1,wherein the control module determines whether the predetermined channel is positioned in the deep fading section based on a frequency response characteristic obtained by analyzing the channel response signal.

5. The apparatus of claim 4, wherein the control module determines that the predetermined channel is positioned in the deep fading section when the frequency response characteristic is low.

6. The apparatus of claim 1, wherein the control module generates the variable communication signal by varying a frequency condition of the communication signal based on a depth of the deep fading section.

7. The apparatus of claim 6, wherein the frequency condition includes at least one of a frequency phase, amplitude, and a beam pattern.

8. A communication method of a cognitive radio apparatus for performing communication in a cognitive radio network, the method comprising:
selecting a predetermined channel from among multiple channels;
generating a channel estimation signal to be transmitted to a predetermined reception apparatus positioned in the predetermined channel;
transmitting the channel estimation signal to the predetermined reception apparatus;
determining whether the predetermined channel is positioned in a deep fading section based on a channel response signal transmitted from the predetermined reception apparatus; and
transmitting, to the predetermined reception apparatus, at least one of a communication signal set with respect to the predetermined channel and a variable communication signal obtained by varying the communication signal, when the predetermined channel is positioned in the deep fading section.

9. The method of claim 8, wherein the transmitting generates the variable communication signal by varying a frequency condition of the communication signal based on a depth of the deep fading section.

10. The method of claim 9, wherein the frequency condition includes at least one of a frequency phase, amplitude, and a beam pattern.
